(19) United States
(12) Patent Application Publication
(10) Pub. No.: US 2025/0217422 A1
(43) Pub. Date: Jul. 3, 2025

(54) HIGHLY-INFLUENTIAL-USER SEARCH APPARATUS, HIGHLY-INFLUENTIAL-USER SEARCH METHOD, AND PROGRAM

(71) Applicant: NIPPON TELEGRAPH AND TELEPHONE CORPORATION, Tokyo (JP)

(72) Inventors: Midori KAWADA, Tokyo (JP); Minako HARA, Tokyo (JP); Masahiro SOTOMA, Tokyo (JP); Xiaoxi ZHANG, Tokyo (JP); Machiko SHINOZUKA, Tokyo (JP)

(73) Assignee: NIPPON TELEGRAPH AND TELEPHONE CORPORATION, Tokyo (JP)

(21) Appl. No.: 18/848,869

(22) PCT Filed: Mar. 24, 2022
(86) PCT No.: PCT/JP2022/014154

§ 371 Date: Sep. 19, 2024

(51) Int. Cl. G06F 16/953; G06Q 30/04; G06Q 50/00

(52) U.S. Cl. CPC G06F 16/953; G06Q 30/04; G06Q 50/01

(57) ABSTRACT

An object of the present disclosure is to efficiently collect data on posts useful for improving services from among an enormous amount of data on the Web.

Thus, the present disclosure is a highly influential user search device for searching for data of a post of a highly influential user from data of posts on the Web, the highly influential user search device comprising: an input unit configured to input data of a predetermined post related to a predetermined service on the Web; a post analysis unit configured to perform analysis for estimating at least one of data on a service use history of a user related to the predetermined service, data on influence of the user related to the predetermined service, and data on a billing status of the user related to the predetermined service, on the basis of the data of the predetermined post; a score calculation unit configured to sum up scores and specify a user with a high score equal to or greater than a predetermined value, on the basis of a result of the estimation; and an output unit configured to output data of a specific post of the user with the high score.

### TECHNICAL FIELD

The present disclosure relates to a technique for extracting a post from the Web (Web) such as an SNS (Social Networking Service) on the basis of user characteristics.

### BACKGROUND ART

In recent years, the importance of marketing using SNS has been increased in services. Since an enormous amount of reviews and reactions have been posted for services, SNS is a place where developers of the services can acquire users' authentic voices. However, from an enormous amount of posts, it is difficult to extract users' feedback that has a large impact on the services, such as sales, influence on SNS, and long-term usage. Therefore, conventionally, the voices of the users have been collected and totalized by Web questionnaires and the like. For example, in case of a pricing service, a small number of people charged a high bill account for a high percentage in terms of the sales proceeds (see NPL 1), as shown in FIG. 11. FIG. 11 is a diagram showing the ratio of the number of users (left) and the ratio of the amount of money (right) based on the amount of bill.

### CITATION LIST

### Non Patent Literature

[NPL 1] Mitsubishi Research Institute, Inc. “Questionnaire results on smartphone games,” Mar. 24, 2016, p. 1-48 <https://www.caa.go.jp/policies/policy/consumer_policy/policy_coordination/internet_committee/pdf/160324shiryol-1.pdf>

### SUMMARY OF INVENTION

### Technical Problem

However, when collecting and totalizing users' voices by Web (Web) questionnaires or the like, it is difficult to efficiently collect opinions of high importance. Another problem is that the reactions of users who do not participate in Web questionnaires cannot be obtained.

The present invention has been made to solve the above problems, and an object of the present invention is to efficiently collect data of posts useful for improving services from an enormous amount of data on the Web.

### Solution to Problem

In order to solve the above problems, an invention according to claim 1 is a highly influential user search device for searching for data of a post of a highly influential user from data of posts on the Web, the highly influential user search device comprising: an input unit configured to input data of a predetermined post related to a predetermined service on the Web; a post analysis unit configured to perform analysis for estimating at least one of data on a service use history of a user related to the predetermined service, data on influence of the user related to the predetermined service, and data on a billing status of the user related to the predetermined service, on the basis of the data of the predetermined post; a score calculation unit configured to sum up scores and specify a user with a high score equal to or greater than a predetermined value, on the basis of a result of the estimation; and an output unit configured to output data of a specific post of the user with the high score.

### Advantageous Effects of Invention

As described above, according to the present invention, it is possible to efficiently collect data of posts useful for improving services from an enormous amount of data on the Web.

### BRIEF DESCRIPTION OF DRAWINGS

FIG. 1 is a schematic diagram of a communication system.

FIG. 2 is a diagram of an electrical hardware configuration of a highly influential user search device.

FIG. 3 is a diagram of an electrical hardware configuration of a communication terminal.

FIG. 4 is a functional configuration diagram of the highly influential user search device.

FIG. 5 is a flowchart showing highly influential user search processing.

FIG. 6 is a diagram showing an example of the oldest tweet that uses a service.

FIG. 7 is a diagram showing an example of a tweet with a high impression.

FIG. 8 is a diagram showing an example of a post in which a billing status can be seen is shown.

FIG. 9 is a diagram showing a product price list for service A.

FIG. 10 is a diagram showing an example of a post to be displayed.

FIG. 11 is a diagram showing the ratios of the number of users (left) and the ratios of the amounts of money (right) based on the amounts of bills.

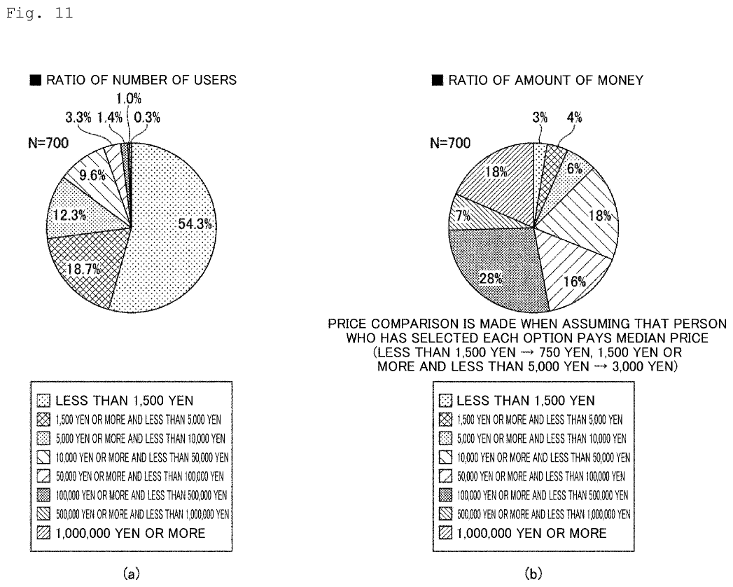

### DESCRIPTION OF EMBODIMENTS

Embodiments of the present invention will be described below with reference to the drawings.

### [System Configuration of Embodiment]

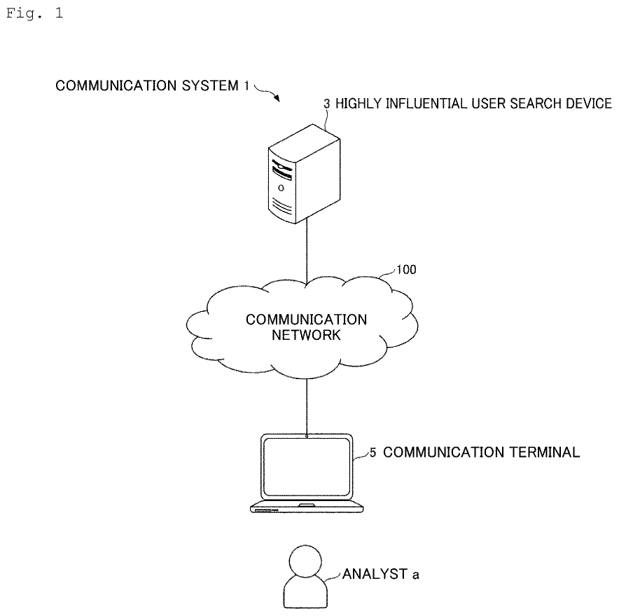

First, the outline of a configuration of a communication system according to the present embodiment will be described with reference to FIG. 1. FIG. 1 is a schematic diagram of a communication system according to an embodiment of the present invention.

As illustrated in FIG. 1, a communication system 1 of the present embodiment is constructed by a highly influential user search device 3 and a communication terminal 5. The communication terminal 5 is managed and used by an analyst a.

The highly influential user search device 3 and the communication terminal 5 can communicate with each other via a communication network 100 such as the Internet. The connection form of the communication network 100 may be either wireless or wired.

The highly influential user search device 3 is composed of one or more computers. When the highly influential user search device 3 is composed of a plurality of computers, it may be indicated as a “highly influential user search device” or as a “highly influential user search system.”

The highly influential user search device 3 focuses on the degree of influence of a user, scores three indexes (attributes), i.e., a service use history (use history) of the user, transmission power of the user, and a billing status of the user for the service, and thereby extracts the opinion of the user having a high degree of influence. The three indexes are not limited to the above. In addition, indexes such as the gender and age may be taken into consideration.

The communication terminal 5 is a computer, and FIG. 1 shows a laptop as an example. In FIG. 1, the analyst a operates the communication terminal 5. The highly influential user search device 3 may perform processing independently without using the communication terminal 5.

### [Hardware Configuration]

### <Hardware Configuration of Highly Influential User Search Device)

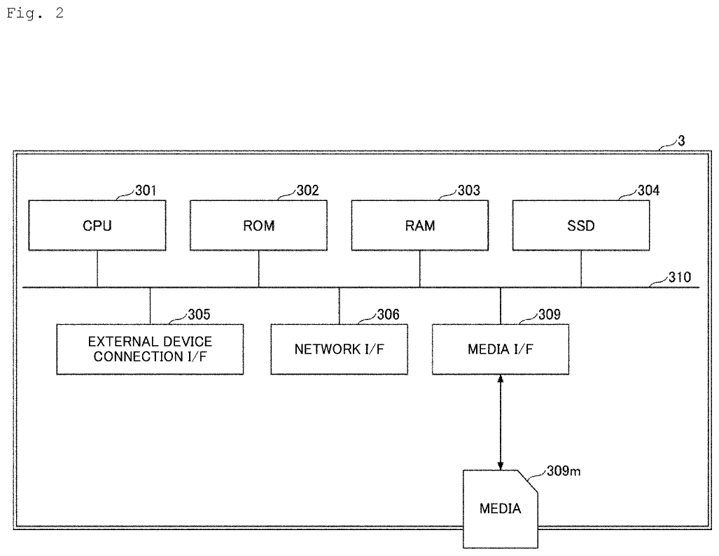

Next, an electrical hardware configuration of the highly influential user search device 3 will be described with reference to FIG. 2. FIG. 2 is a diagram showing the electrical hardware configuration of the highly influential user search device.

As shown in FIG. 2, the highly influential user search device 3 includes, as a computer, a CPU (Central Processing Unit) 301, a ROM (Read Only Memory) 302, a RAM (Random Access Memory) 303, an SSD (Solid State Drive) 304, an external device connection I/F (Interface) 305, a network I/F 306, a media I/F 309, and a bus line 310.

Of these, the CPU 301 controls the operation of the entire highly influential user search device 3. The ROM 302 stores a program used for driving the CPU 301, such as an IPL (Initial Program Loader). The RAM 303 is used as a work area of the CPU 301.

The SSD 304 reads or writes various types of data according to the control of the CPU 301. An HDD (Hard Disk Drive) may be used instead of the SDD 304.

The external device connection I/F 305 is an interface for connecting various external devices. The external devices in this case are a display, a speaker, a keyboard, a mouse, a USB (Universal Serial Bus) memory, a printer, and the like.

The network I/F 306 is an interface for data communication performed via the communication network 100.

The media I/F 309 controls reading or writing (storage) of data to or from a recording medium 309m such as a flash memory. The recording medium 309m also includes a DVD (Digital Versatile Disc), a Blu-ray Disc (registered trademark), and the like.

The bus line 310 is an address bus, a data bus, or the like for electrically connecting each component such as the CPU 301 shown in FIG. 2.

### <Hardware Configuration of Communication Terminal>

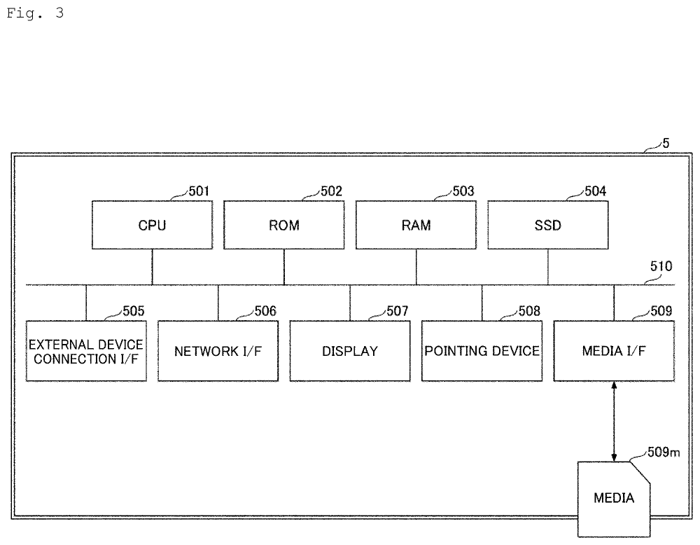

Next, an electrical hardware configuration of the communication terminal 5 will be described with reference to FIG. 3. FIG. 3 is a diagram showing the electrical hardware configuration of the communication terminal.

As shown in FIG. 3, the communication terminal 5 includes, as a computer, a CPU 501, a ROM 502, a RAM 503, an SSD 504, an external device connection I/F (Interface) 505, a network I/F 506, a display 507, a pointing device 508, a media I/F 509, and a bus line 510.

Of these, the CPU 501 controls the operation of the entire communication terminal 5. The ROM 502 stores a program used for driving the CPU 501, such as IPL. The RAM 503 is used as a work area for the CPU 501.

The SSD 504 reads or writes various types of data according to the control of the CPU 501. An HDD (hard disk drive) may be used instead of the SSD 504.

The external device connection I/F 505 is an interface for connecting various external devices. The external devices in this case are a display, a speaker, a keyboard, a mouse, a USB memory, a printer, and the like.

The network I/F 506 is an interface for data communication performed via the communication network 100.

The display 507 is a type of display means such as a liquid crystal or organic EL (Electro Luminescence) for displaying various images.

The pointing device 508 is a type of input means for selecting and executing various instructions, selecting an object to be processed, and moving a cursor. When the analyst a uses a keyboard, the function of the pointing device 508 may be turned off.

The media I/F 509 controls reading or writing (storage) of data to or from a recording medium 509m such as a flash memory. The recording medium 509m includes a DVD, a Blu-ray Disc (registered trademark), and the like.

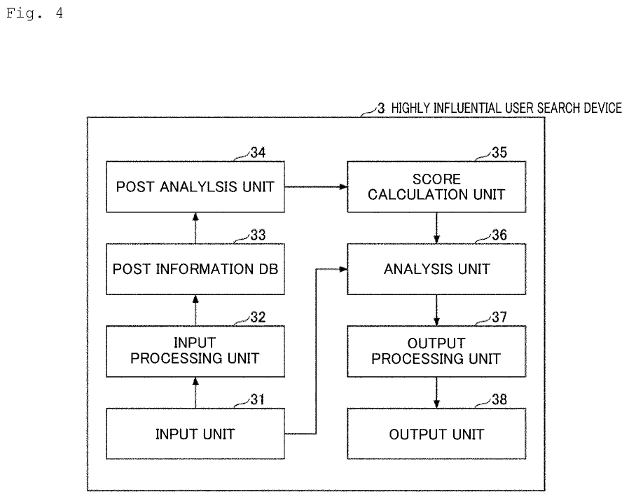

The bus line 510 is an address bus, a data bus, and the like for electrically connecting each component such as the CPU 501 shown in FIG. 4.

### [Functional Configuration of Highly Influential User Search Device]

Next, a functional configuration of the highly influential user search device will be described with reference to FIG. 4. FIG. 4 is a diagram showing a functional configuration of the highly influential user search device according to an embodiment of the present invention.

In FIG. 4, the highly influential user search device 3 includes an input unit 31, an input processing unit 32, a post analysis unit 34, a score calculation unit 35, an analysis unit 36, an output processing unit 37, and an output unit 38. These units are functions realized by commands from the CPU 301 shown in FIG. 2 on the basis of programs.

Further, a post information DB (Data Base) 33 is constructed in the RAM 303 or the HD 304 in FIG. 2.

### <Post Information DB>

In the post information DB 33, data such as the date, text, and impression of a post that are acquired from data of the post are managed.

### <Each Functional Configuration>

Each functional configuration of the highly influential user search device will be described next with reference to FIGS. 2 to 4.

The input unit 31 receives input of post data of an unspecified number of users, the post data being related to a predetermined service, from the analyst a via the communication terminal 5 and the network I/F 306.

The input processing unit 32 processes the data input by the input unit 31 so that the data can easily be processed thereafter.

The post analysis unit 34 performs analysis for estimating data on a service use history of a user related to a predetermined service, data on the influence of the user related to the predetermined service, and data on a billing status of the user related to the predetermined service, on the basis of the data on a predetermined post.

The score calculation unit 35 sums up scores S on the basis of the result estimated by the post analysis unit 34, and specifies a user having a high score equal to or higher than a predetermined value.

The analysis unit 36 communicates with an external server or the like from the input unit 31 through the communication network 100 to calculate and adjust each of constants α, β, γ described later.

The output processing unit 37 acquires analysis data (data on a specific post by the user with a high score) from the analysis unit 36, and creates analysis result data which can be browsed by the analyst a.

The output unit 38 outputs the analysis result data. Examples of an output method include transmitting data on an output result to the communication terminal 5, displaying the data, or printing the data.

### [Processing or Operation of Embodiment]

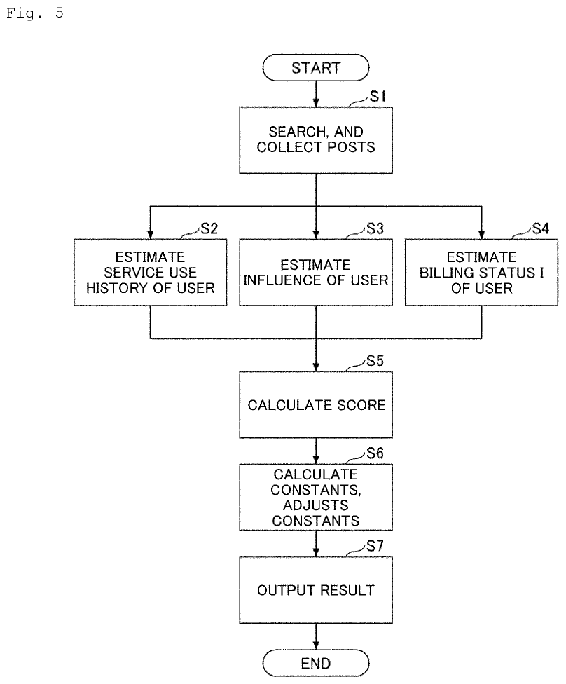

The processing or operation of the present embodiment will be described next in detail with reference to FIGS. 5 to 10. FIG. 5 is a flow chart showing search processing for searching for a highly influential user. Described here is an example in which the analyst a collects the reputation of a user about a service A as the predetermined service developed by a company of the analyst a.

STEP 1: As shown in FIG. 5, first, the input unit 31 acquires data on an SNS post from the analyst a via the communication terminal 5, by the name of the service. Alternatively, the input unit 31 directly retrieves the data on the SNS post, by the name of the service. The input processing unit 32 acquires the date, text, and impression of the post from the data on the post, and stores these pieces of information in the post information DB 33.

For example, the input unit 31 searches Twitter as an example of the data on a post by the name of the service A, and acquires data on a predetermined post.

STEP 2: The post analysis unit 34 retrieves (acquires) the data on the oldest post indicating that an arbitrary user uses the predetermined service, and estimates the service use history of the user, including normalization.

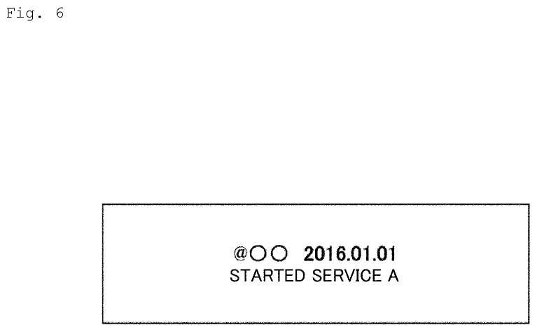

For example, as shown in FIG. 6, the post analysis unit 34 searches the past tweets by a user, and searches for the oldest tweet indicating that the user uses the service A, to estimate the service use history. FIG. 6 is a diagram showing an example of the oldest tweet showing that the user uses the service.

STEP 3: From the data on the posts by the arbitrary user over a predetermined period (e.g., one path) from present to past, the post analysis unit 34 extracts (acquires) a predetermined number of tweets that show impressions (number of times) equal to or greater than a threshold, sums up the impressions, then normalizes the impressions, and estimates the influence of the user.

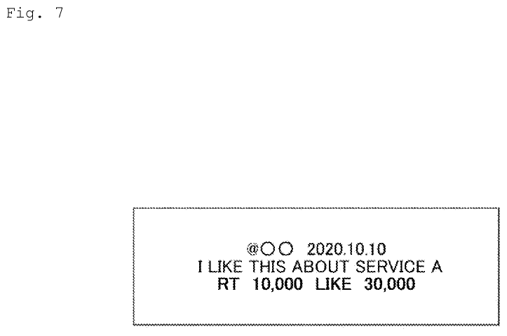

For example, as shown in FIG. 7, the post analysis unit 34 extracts ten tweets by the user that have the highest impression among the posts over the past one month, to estimate the influence of the user. FIG. 7 is a diagram showing an example of a tweet with the high impression.

STEP 4: The post analysis unit 34 retrieves (acquires) a post indicating the billing status of the arbitrary user over a predetermined period (e.g., one month) from present to past, and estimates the billing status of the user, including normalization. The billing status is estimated by extracting words (“paid plan,” “oo coins,” and “oo gashapons,” etc.) representing an in-service pricing system.

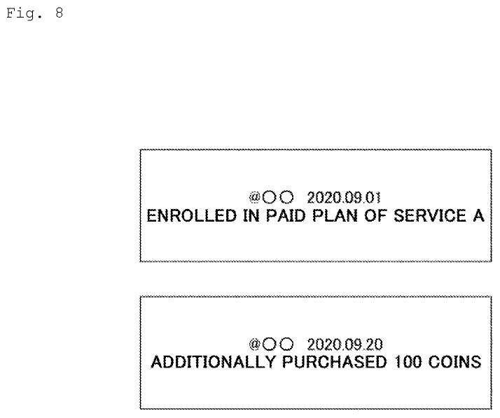

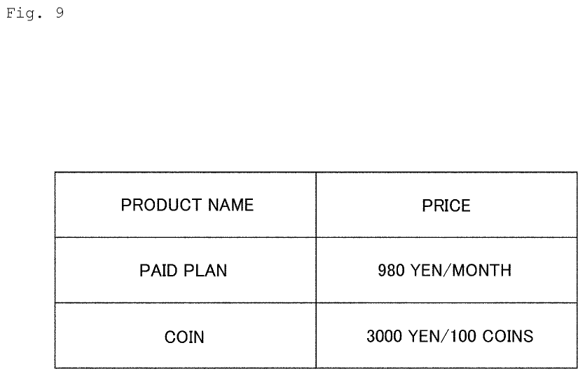

For example, as shown in FIGS. 8 and 9, the post analysis unit 34 retrieves a post indicating the billing status of the user over the past one month, and estimates the amount of money by using (Equation 1).

$$[ Math . 1 ]$$

$$M = \sum ( f ) \qquad ( Equation 1 )$$

f: Estimated amount of bill per tweet

The processing is further explained.

STEP 5: The score calculation unit 35 sums up the scores by using (equation 2) to specify a user (specific user) having a high score equal to or greater than a predetermined value. Note that (equation 2) is only an example.

$$[ Math . 2 ]$$

$$S = α \frac{{D}_{S}}{{D}_{R}} + β \sum ( R + L ) + γ M \qquad ( Equation 2 )$$

S: Influence score
α, β, γ: Constants
D_{R}: The number of days from the release date of service A
D_{S}: The number of days since the oldest tweet indicating that
the user uses the service A
R: Rt number (total sum of positive impressions)
L: The number of “likes”
M: Estimated amount of charge

The processing is further explained.

The score calculation unit 35 also normalizes Σ(R+L) in the following procedure.

The score calculation unit 35 randomly selects thirty or more posts from the posts mentioning the service, and creates a t distribution of an impression. The score calculation unit 35 derives a standard deviation of Σ(R+L) from the created distribution. In the present embodiment, although the method of adopting the t distribution for normalization is employed, another method may be employed.

The score calculation unit 35 can also calculate a score by using at least one of the results of estimating the service use history of the user (see STEP 2), estimating the influence of the user (see STEP 3), and estimating the billing status of the user (see STEP 4). For example, in the case of the analysis of a service relating to a new product recently released, the importance of the service use history (see STEP 2) is considered to be low and therefore may be excluded from the column for the influence score.

STEP 6: The analysis unit 36 communicates with an external server or the like from the input unit 31 via the communication network 100, to calculate and adjust each of the constants α, β, γ.

For example, when the importance of a long-term user is low because the service A has just been released, the analysis unit 36 adjusts the constant α to be small. When importance needs to be given to the opinion of an influencer in order to pay attention to public relations, the analysis unit 36 adjusts the constant β to be large.

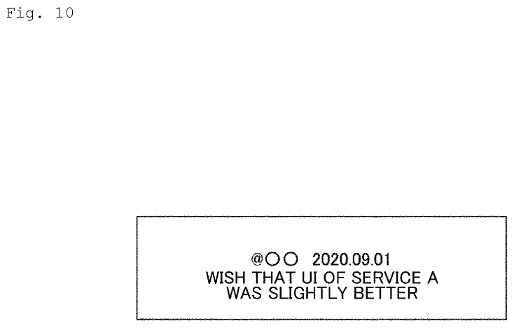

STEP 7: The output processing unit 37 acquires the analysis data (data on the specific post by the user with a high score) from the analysis unit 36, and creates analysis result data that can be browsed by the analyst a. The output unit 38 outputs analysis result data including the post by the high score user as shown in FIG. 10.

### Advantageous Effects of Embodiment

As described above, the present embodiment brings about the effect of efficiently collecting the posts useful for improving a service from an enormous amount of data, by using (equation 2) for estimating an attribute of a user from data on a post on the Web (Web) such as SNS. For example, by incorporating opinions of users having high influence on services, opinions having high importance can be efficiently collected. Further, the response of a user who does not voluntarily participate in the questionnaire can be obtained. Further, when an influencer is to be used in releasing a new application, retrieval is performed by an existing similar game to enable optimum user selection.

### [Supplementary Notes]

The present invention is not limited to the embodiments described above, and may have configurations or processing (operations) described below.

(1) The highly influential user search device 3 can also be implemented by a computer and a program, and the program can be recorded on a (non-temporary) recording medium or provided through the communication network 100.

(2) In communication between the highly influential user search device 3 and the communication terminal 5, another device (server, router, etc.) may relay data. For example, although the present specification describes for the sake of simplification that the input unit 31 of the highly influential user search device 3 transmits data to the communication terminal 5, this transmission processing is meant to also include the case in which the data is relayed by another device.

(4) Although a laptop is shown as an example of the communication terminal 5 in the foregoing embodiments, the communication terminal 5 is not limited thereto and may be, for example, a desktop computer, a tablet terminal, a smartphone, a smartwatch, a car navigation device, a refrigerator, a microwave, or the like.

(5) Each of the CPUs 301 and 501 may not be only a single one but may be a plurality of CPUs.

(6) A neural network may be used in at least a part of the processing executed by the post analysis unit 34 or the analysis unit 36 described above.

### REFERENCE SIGNS LIST

1 Communication system
3 Highly influential user search device
5 Communication terminal
31 Input unit
32 Input processing unit
33 Post information DB (example of post information management unit)
34 Post analysis unit
35 Score calculation unit
36 Analysis unit
37 Output processing unit
38 Output unit

1. A highly influential user search device for searching for data of a post of a highly influential user from data of posts on the Web, the highly influential user search device comprising:
an input unit configured to input data of a predetermined post related to a predetermined service on the Web;
a post analysis unit configured to perform analysis for estimating at least one of data on a service use history of a user related to the predetermined service, data on influence of the user related to the predetermined service, and data on a billing status of the user related to the predetermined service, on the basis of the data of the predetermined post;
a score calculation unit configured to sum up scores and specify a user with a high score equal to or greater than a predetermined value, on the basis of a result of the estimation; and
an output unit configured to output data of a specific post of the user with the high score.

2. A highly influential user search device for searching for data of a post of a highly influential user from data of posts on the Web, the highly influential user search device comprising:
an input unit configured to input data of a predetermined post related to a predetermined service on the Web;
a post analysis unit configured to perform analysis for estimating data on a service use history of a user related to the predetermined service, data on influence of the user related to the predetermined service, and data on a billing status of the user related to the predetermined service, on the basis of the data of the predetermined post;
a score calculation unit configured to sum up scores and specify a user with a high score equal to or greater than a predetermined value, on the basis of a result of the estimation; and
an output unit configured to output data of a specific post of the user with the high score.

3. The highly influential user search device according to claim 2, wherein the post analysis unit normalizes the data of a service use history of a user related to the predetermined service, the data on influence of the user related to the predetermined service, and the data on a billing status of the user related to the predetermined service, respectively.

4. The highly influential user search device according to claim 1, wherein the post analysis unit estimates a service use history of the user by acquiring the oldest post indicating that the user uses a predetermined service.

5. The highly influential user search device according to claim 1, wherein the post analysis unit acquires a predetermined number of tweets having impressions equal to or greater than a threshold among posts made by a user over a predetermined period from present to past, and estimates influence of the user by summing up the impressions.

6. The highly influential user search device according to claim 1, wherein the post analysis unit acquires data of a post indicating a billing status of a user over a predetermined period from present to past, and thereby estimates the billing status of the user.

7. A highly influential user search method executed by a highly influential user search device to search for data of a post of a highly influential user from data of posts on the Web, wherein
the highly influential user search device includes:
an input unit configured to input data of a predetermined post related to a predetermined service on the Web;
a post analysis unit configured to perform analysis for estimating at least one of data on a service use history of a user related to the predetermined service, data on influence of the user related to the predetermined service, and data on a billing status of the user related to the predetermined service, on the basis of the data of the predetermined post;
a score calculation unit configured to sum up scores and specify a user with a high score equal to or greater than a predetermined value, on the basis of a result of the estimation; and
an output unit configured to output data of a specific post of the user with the high score.

8. A program causing a computer to perform the method according to claim 7.

9. The highly influential user search device according to claim 2 wherein, the post analysis unit estimates a service use history of the user by acquiring the oldest post indicating that the user uses a predetermined service.

10. The highly influential user search device according to claim 2 wherein, the post analysis unit acquires a predetermined number of tweets having impressions equal to or greater than a threshold among posts made by a user over a predetermined period from present to past, and estimates influence of the user by summing up the impressions.

11. The highly influential user search device according to claim 2 wherein, the post analysis unit acquires data of a post indicating a billing status of a user over a predetermined period from present to past, and thereby estimates the billing status of the user.

12. The highly influential user search method according to claim 7 wherein, the post analysis unit estimates a service use history of the user by acquiring the oldest post indicating that the user uses a predetermined service.

13. The highly influential user search method according to claim 7 wherein, the post analysis unit acquires a predetermined number of tweets having impressions equal to or greater than a threshold among posts made by a user over a predetermined period from present to past, and estimates influence of the user by summing up the impressions.

14. The highly influential user search method according to claim 7 wherein, the post analysis unit acquires data of a post indicating a billing status of a user over a predetermined period from present to past, and thereby estimates the billing status of the user.
